(19) United States
(12) Patent Application Publication
(10) Pub. No.: US 2005/0176599 A1
(43) Pub. Date: Aug. 11, 2005

(54) Controlled delivery system for household products

(76) Inventors: Catharine J. Bergquist, Woodbridge, NJ (US); Daniel Stauffer, Lawrenceville, NJ (US); Paul M. Ferm, Morristown, NJ (US)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/038,310

(22) Filed: Jan. 19, 2005

Related U.S. Application Data
(63) Continuation-in-part of application No. 10/342,672, filed on Jan. 15, 2003.
Application No. 10/342,672 is a continuation of application No. 09/709,062, filed on Nov. 9, 2000, now Pat. No. 6,531,444.

(51) Int. Cl. C11D 3/50

(52) U.S. Cl. 510/101

(57) ABSTRACT

The present invention relates to a controlled delivery system that can be incorporated in liquid, as well as, dry granular, or powder, household products, such as dishwashing detergents, surface cleaners, deodorizers, animal litters and cleaning wipes The controlled delivery system of the present invention is a solid, substantially spherical particle comprising a hydrophobic material. The particles can include cationic charge enhancing agents. The particles can also include a fragrance. The particle can have an average particle diameter of from about 1 micron to about 500 microns. The controlled delivery system of the present invention can be utilized to deliver a broad range of fragrance ingredients and prolong fragrance release over an extended period of time. The invention also pertains to household products comprising the controlled release system of the present invention.

### CROSS REFERENCE TO RELATED APPLICATION

This application is a continuation-in-part of U.S. patent application Ser. No. 10/342,672, which is a continuation of U.S. patent application Ser. No. 09/709,062, now U.S. Pat. No. 6,531,444. The entirety of each is hereby incorporated by reference into this application.

### BACKGROUND OF THE INVENTION

1. Field of the Invention

The present invention relates to a controlled release carrier system that can be incorporated into household products, such as cleaning compositions, dishwashing detergent formulations, deodorizer formulations, animal litter and cleaning wipes, and other household products, and that enhances fragrance deposition and which provides prolonged release of an active agent, such as a fragrance over an extended period of time.

2. Description of the Related Art

The household industry has searched for many years for ways to enhance the performance of household products and make them more aesthetically pleasing for the consumers. Consumer acceptance of household products is determined not only by the performance achieved with these products but the aesthetics associated therewith. Fragrance is an important aspect of the successful household products and they are being utilized, in addition to imparting an aesthetically pleasing odor, to convey to the consumer the product performance and effectiveness (i.e., the surface is clean, etc.).

Fragrances are typically added to household products to provide a fresh, clean impression for these products. While the fragrance may not add to the performance of the household products, it does make these products more aesthetically pleasing and the consumer has come to expect such products to have a pleasing odor. The fragrance plays a major, and often determining, role for the consumer in selecting and purchasing the household product. Consumers are becoming increasingly educated and expect a high level of sophistication in their household products. Many consumers would prefer for the fragrance, present in these products, to be deposited and remain there for an extended period of time to convey a lasting impression of freshness. Consumers are also interested in household products that deposit high level of fragrance. Fragrance creation for household products is restricted not only by considerations such as availability and cost, but also by compatibility of the fragrance ingredients with other components in the product composition.

U.S. Pat. No. 4,402,856 describes the use of coacervation technique to create perfume particles for diverse products including washing agents, household agents and cellulose nappies composed of gelatin or a mixture of gelatin with gum arabic, carboxymethylcellulose and/or anionic polymers. The gelatin is hardened with a natural and/or synthetic tanning agent and with a carbonyl compound.

U.S. Pat. No. 4,919,841 discloses wax encapsulated actives based on emulsion process for household applications including fabric. The process for preparing encapsulated active particles comprises the steps of: dispersing active materials in molten wax; emulsifying the active/wax dispersion in aqueous surfactant solution; quenching the capsules by cooling; and retrieving solidified capsules. The active materials may be selected from chlorine or oxygen bleaching agents, bleach precursors, enzymes, perfumes, fabric softening agents, and surfactants. The resultant capsules are in a form of dispersion (liquid) and have utility for cleaning compositions such as automatic dishwashing detergent formulations.

U.S. Pat. No. 6,042,792 issued to the inventor of this disclosure also describes an aqueous dispersion. A controlled, time-release microparticulate active and bioactive compositions (including perfuming compositions) for targeted delivery to services such as skin, hair and fabric and the environment proximate thereto is described in which the active and bioactive materials have a calculated log P values of between 1 and 8 (P being the n-octanol-water partition coefficient). Such compositions include the active or bioactive material in single phase, solid solution in a wax or polymer matrix also having coated thereon and/or containing a compatible surfactant. Also described are processes and apparatus for preparing such compositions and processes for using same.

Water soluble polymers have also been used to encapsulate fragrance oils. Such capsules have proved useful in releasing perfume in deodorants. However, such capsules have not been commercially successful in extended release of perfume from fabrics. U.S. Pat. No. 5,425,887 discloses an encapsualted perfume system in tumble dryer articles. The encapsulating material is a water-soluble natural or synthetic polymer with a molecular weight of less than about 300,000 that will release the perfume in response to moisture. Since these systems are water sensitive, these types of particles cannot be incorporated in aqueous fabric softener compositions.

U.S. Patent Nos. 5,066,419 and 5,154,842 disclose coated perfume particles. The perfume particles comprise perfume dispersed within certain water-insoluble non-polymeric carrier materials and encapsulated in a protective shell by coating with a friable coating material. The coated particles allow for preservation and protection of perfumes, which are susceptible to degradation or loss in storage and in cleaning compositions. In use, the surface coating fractures and the underlying carrier/perfume particles deliver a large variety of perfume types to fabrics or other surfaces.

U.S. Pat. Nos. 4,973,422 and 5,137,646 disclose perfume particles for use in cleaning and conditioning compositions. Perfume particles are disclosed comprising perfume dispersed within wax materials. The particles can be further coated with a material that makes the particles more substantive to the surface being treated. Such materials help to deliver the particles and maximize perfume release. Generally, the coating materials are water-insoluble cationic materials. Cleaning and conditioning compositions comprising these perfume particles are also disclosed.

U.S. Pat. No. 6,024,943 discloses particles containing absorbed liquids and methods of making them. Perfume is absorbed within organic polymer particles, which have a further polymer at their exterior. The polymer incorporates free hydroxyl groups and serves to promote deposition of the particles from a wash or rinse liquor. The polymer may be part of an encapsulating shell, but more conveniently is used as a stabilizer during polymerization of the particles. Highly hydrolyzed polyvinyl alcohol is preferred. Particles containing organic polymer, which are insoluble in water, with liquid imbibed by the particles, the particles having at their exterior, a polymer which incorporates free hydroxy groups.

U.S. Pat. No. 5,476,660 discloses compositions to deposit an active substance on a target surface. The active substance is left on the surface after the product is rinsed off the surface. The preferred deposition is from compositions containing an anionic or nonionic active in the co-presence of an anionic surfactant. The compositions contain carrier particles having a zwitterionic or cationic surface and a plurality of outwardly protruding filaments containing charged organocarbyl groups. The term “zwitterionic” employed in this patent means a mixture of cationic and anionic (not necessarily neutral); thus the surface of the zwitterionic particles, have both cationic and anionic groups (i.e., positively charged and negatively charged organocarbyl groups). The active substance is contained within the carrier particles. Examples of target surfaces are mammalian skin, hair or nails.

U.S. Pat. No. 6,362,159 describes a domestic care particle comprising a fragrance particle. The particle comprises a fragrance composition and at least one silicone polymer provided at least 20% of the silicone atom in the silicone polymer have a substituent of 16 carbon atoms or more.

WO 03/083031 discloses a blend of a fragrance composition and a mixture of a wax and a liquid silicone compatible with the wax. An emulsion can be formed by emulsifying the blend in the continuous phase using at least one surfactant. The emulsion can be dispersed in a liquid cleaning product. Alternatively, the blend can be emulsified in the liquid cleaning product.

The prior art of which applicant is aware does not set forth a fragrance controlled release system that can be incorporated in liquid, as well as, dry granular, or powder, household products to enhance fragrance performance. There is also a need for a fragrance carrier system, for household products or wipes that will allow using a wider range of fragrance ingredients and improved fragrance substantivity and longevity. It is desirable to provide a control release system for overcoming these limitations. It is also desirable to provide a method using an efficient and economical process for delivering a broad range of fragrance ingredients from a household product and prolong fragrance release over an extended period of time.

### SUMMARY OF THE INVENTION

The present invention relates to an improved carrier system for fabric care products, such as fabric softener, laundry detergents, rinse added products, and other fabric care products, comprising particles formed of hydrophobic polymers and copolymers in combination with an active agent, such as a fragrance, cationic charge booster and cationic fabric softener agent to improve fragrance deposition onto the laundered fabric. The fragrance carrier system also provides controlled release or prolonged fragrance release from the dry laundered fabric over an extended period of time, or yields a high impact fragrance “burst” upon ironing the fabric.

In one embodiment, the present invention provides an improved fragrance carrier system for fabric care products, that has improved fragrance substantivity to bring the fragrance onto clothes which have been laundered and/or which have been treated with fabric softeners and/or which have been treated with rinse added, or drier-added fabric softener products. In the household industry, the term “substantivity” refers to the deposition of the fragrance on the clothes and the retention and perception of the fragrance on the laundered clothing and on the clothing treated with fabric care product. The cationic surface-active agents comprising the fragrance carrier system of the present invention allow a wide range of fragrances and fragrance ingredients to be compatible within the carrier composition and increase the substantivity of fragrances and fragrance ingredients that are currently not substantive on fabric. The fragrance-carrier system also provides prolong fragrance release from the dry laundered fabric over an extended period of time, or yields a high impact fragrance “burst” upon ironing the fabric. In addition, the production of the fragrance-carrier system utilizes minimum processing steps and is efficient and economical.

The carrier system of the present invention is a solid, substantially smooth and spherical particle characterized by:
(i) protection of the volatile constituents of the fragrance during storage, until needed;
(ii) enhanced fragrance deposition onto fabric;
(iii) prolonged fragrance release from the dry laundered fabric over an extended period of time; or
(iv) yield high impact fragrance “burst” upon ironing the fabric.

The invention also provides a process for producing the solid particles of the present invention that comprises the steps of:
(i) heating matrix materials, such as solid hydrophobic polymers and co-polymers, cationic charge boosters, and optionally cationic fabric softening agents to about 10° C. above the melting point of the ingredients, with continuous agitation;
(ii) adding an agent such as a fragrance to the melt with continuous agitation; and
(iii) cooling said melt to ambient temperature to form a dry free-flowing powder composition. The molten mixture can be converted into a free-flowing powder by spraying processes known in the art, such as spray chilling, granulation, and the like, to create fine or very fine particles, mostly of a substantially spherical shape, having an average particle diameter of from about 1 microns to about 500 microns, or more preferably having an average particle diameter of from about 50 microns to about 200 microns.

The invention also provides a fabric care product such as fabric softener, laundry detergents, rinse added products, and other fabric care products, comprising the fragrance controlled release system of the present invention. Fabric laundered with powder laundry detergent and liquid fabric softener comprising the particles of the present invention were observed to exhibit high level of fragrance (high odor intensity) in both the wet and the dry state and fragrance perception on the dry laundered fabric has been observed to be perceived over an extended period of time, i.e., two to three weeks.

The present invention addresses the foregoing need to increase the deposition of wide range of fragrance and fragrance ingredients onto fabric and prolong their release so that the laundered fabric remains aesthetically pleasing for an extended period of time by employing an advanced carrier system to bring the fragrance onto the clothes.

It is believed that the highly substantive cationic charge booster in conjunction with the cationic fabric softening agents in the particles composition becomes associated, in use of the composition, with the fabric and assists in adhering the particles onto fabric during the washing cycle through both particle entrainment and electrostatic interactions to effectively deliver fragrance onto fabric and sustain their release rate. The hydrophobic polymers and copolymers sustain the diffusion rate of the fragrance through the particles and enable the fragrance to be released from the dry laundered fabric over an extended period of time, or during heat treatment such as ironing.

The fragrance-particle of the present invention can comprises from about 1% to about 95% by weight hydrophobic polymers, hydrophobic copolymers, or a mixture thereof, from about 0.1% to about 10% by weight cationic charge booster, from about 0.0% to about 50% by weight cationic fabric softening agents, and from about 1% to about 50% by weight fragrance. The particles have an average particle size in the range from about 1 micron to about 500 microns and having a melting point in the range from about 60° C. to about 150° C. The particles can be incorporated into any fabric care products, preferably in fabric softener or laundry detergent compositions.

Additional components can be added to the fragrance carrier system or can be incorporated into the particle matrix. For example, additional components that can be included in the fragrance carrier system are: ironing aids such as silicones; anti-shrinkage agents; anti-wrinkle agents; fabric crisping agents; spotting agents; germicides; fungicides; stabilizers preservatives; bactericides which can be effective to protect the composition or to treat fabrics; flow agents; and mixtures thereof. The additional components are usually present in an amount from about 1% to about 10% by weight of the particles.

In an alternate embodiment, the present invention relates to an improved carrier system for household products, such as cleaning compositions, hard surface cleaning compositions, automatic dishwashing detergent formulations, hand dishwashing detergent formulations, wipe products and deodorizer formulations, comprising particles formed of hydrophobic polymers and copolymers in combination with an active agent, such as a fragrance. The particles can be positively charged. In one embodiment, the composition includes a cationic charge booster to improve fragrance deposition onto a surface. The fragrance carrier system also provides controlled release or prolonged fragrance release from over an extended period of time, or yields a high impact fragrance “burst.”

The fragrance-particle of the present invention can comprise from about 1% to about 95% by weight hydrophobic polymers, hydrophobic copolymers, or a mixture thereof, from about 0.1% to about 10% by weight cationic charge booster and from about 1% to about 50% by weight fragrance. The particles have an average particle size in the range from about 1 micron to about 500 microns and having a melting point in the range from about 60° C. to about 150° C. The particles can be incorporated into any household products.

The carrier system of the present invention can be incorporated in liquid as well as dry granular or powder household compositions and provide long-term storage stability.

The invention will be more fully described by referenced to the following drawings.

### BRIEF DESCRIPTION OF THE DRAWINGS

FIG. 1 is a scanning electron microscopy (SEM) image magnified 500 times of fragrance carrier particles formed by Example 2 of the present invention.

FIG. 2 is a SEM magnified 100 times of fabric washed with a fabric softener including the fragrance carrier particles formed by Example 2.

FIG. 3 is a SEM magnified 350 times of fabric washed with a fabric softener including the fragrance carrier particles formed by Example 2.

FIG. 4 is a Sem magnified 200 times of a fabric washed with a powder laundry detergent including the fragrance carrier particles formed by Example 2.

FIG. 5 is a Sem magnified 500 times of a fabric washed with a powder laundry detergent including the fragrance carrier particles formed by Example 2.

FIG. 6 is a SEM magnified 500 times of a fabric washed with a liquid laundry detergent including the fragrance carrier particles formed by Example 2.

### DETAILED DESCRIPTION

The present invention features a method of controlling the release rate of an active agent, such as a fragrance, that can be incorporated in a fabric care product, over an extended period of time, or yields a high impact fragrance “burst” upon ironing. The carrier system of the present invention comprises substantially solid particles in combination with a cationic charge booster and cationic fabric softener. The term “particles” is intended to describe solid, substantially spherical particulates. It will be appreciated that other particle shapes can be formed in accordance with the teachings of the present invention.

The particles of the present invention have a predetermined particle size. The low end of the useful size range of the particles is limited by undue loss of fragrance from the particle. The permeation rate of the fragrance from the particle is proportional to particle size such that the smaller particles, the faster the rate that fragrance that is being released. Fragrance containing particles of the present invention have an average diameter in the range from about 1 micron to about 500 microns. Preferably, the particle size of the fragrance-containing particles is in the range from about 50 microns to about 200 microns. It has been found that particles within the range of about 50 microns to about 200 microns are efficiently entrained on fabric surfaces and are not noticeable on the fabrics. This linear dimension for any individual particle represents the length of the longest straight line joining two points on the surface of the particle.

Additional components can be added to the fragrance carrier system or can be incorporated into the particle matrix. For example, additional components that can be included in the fragrance carrier system are: ironing aids such as silicones; anti-shrinkage agents; anti-wrinkle agents; fabric crisping agents; spotting agents; germicides; fungicides; stabilizers preservatives; bactericides which can be effective to protect the composition or to treat fabrics; flow agents; and mixtures thereof. The additional components are usually present in an amount from about 1% to about 10% by weight of the particles.

In an alternate embodiment, the present invention relates to a controlled delivery system for use as a household product. Household products include any product used for cleaning, deodorizing or polishing. Some suitable household products include dishwashing detergents, surface cleaners, deodorizers, animal litter and cleaning wipes. Dishwashing detergents can include, for example, automatic dishwashing detergent powders or liquids, and hand dishwashing detergent liquids. Surface cleaners can include, for example, acid hard surface cleaners, basic hard surface cleaners, tile cleaners, glass cleaners, bathroom surface cleaners, furniture polish, carpet powder cleaners, carpet shampoos, automotive cleaners, automotive waxes, automotive polishes and cleaning wipes.

Cleaning wipes can be used for cleaning hard surfaces. Cleaning wipes can comprise single or multiple layers of a material. A wipe product of the present invention comprising multiple layers may be ultrasonically bonded.

The fragrance containing solid particles can be adhered to fibers of single or multiple layers of material. Alternatively, the fragrance containing solid particles can be held between the multiple layers of material. A wide variety of materials can be used as one or more layers of the cleaning wipes. It should have sufficient wet strength, abrasivity, loft and porosity. Examples include nonwoven materials, woven materials, and hydroentangled materials. Some suitable materials for forming the cleaning wipes include cellulose polyester, polypropylene and materials described in U.S. Pat. No. 6,720,301, hereby incorporated by reference into this application. The wipes can be disposable.

I. Cationic Charge Boosters

The fragrance carrier system of the present invention comprises a cationic charge booster. Suitable cationic charge boosters are described in U.S. Pat. No. 6,083,899 hereby incorporated by reference into this application. The preferred cationic charge boosters of the present invention are described herein below.

I.a. Quaternary Ammonium Compounds

A preferred composition of the present invention comprises at least about 0.1%, preferably from about 0.1% to about 10%, more preferably from about 0.1% to about 5% by weight, of a cationic charge booster having the formula: 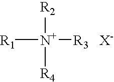
wherein R₁, R₂, R₃, and R₄ are each independently C₁-C₂₂ alkyl, C₃-C₂₂ alkenyl, R₅-Q-(CH₂)ₘ—, wherein R₅ is C₁-C₂₂ alkyl, and mixtures thereof, m is from 1 to about 6; X is an anion. Preferably R₁ is C₆-C₂₂ alkyl, C₆-C₂₂ alkenyl, and mixtures thereof, more preferably R₁ C₁₁-C₁₈ alkyl, C₁₁-C₁₈ alkenyl, and mixtures thereof; R₂, R₃, and R₄ are each preferably C₁-C₄ alkyl, more preferably each R₂, R₃, and R₄ are methyl.

Alternatively, R₁ can be a R₅ -Q-(CH₂)ₘ— moiety wherein R₅ is an alkyl or alkenyl moiety having from 1 to 22 carbon atoms, preferably the alkyl or alkenyl moiety when taken together with the Q unit is an acyl unit. For example, Q can be derived from a source of triglyceride selected from tallow, partially hydrogenated tallow, lard, partially hydrogenated lard, vegetable oils, partially hydrogenated vegetable oils, such as canola oil, safflower oil, peanut oil, sunflower oil, corn oil, soybean oil, tall oil, rice bran oil, and the like and mixtures thereof.

An example of a fabric softener cationic booster comprising a R₅-Q-(CH₂)ₘ— moiety has the formula: 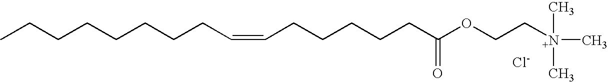
wherein R₅-Q- represents oleoyl units and m is equal to 2.

Preferably X is a softener compatible anion, such as the anion of a strong acid. For example, X can be chloride, bromide, methylsulfate, ethylsulfate, sulfate, nitrate and mixtures thereof. More preferably X is chloride and methyl sulfate.

I.b. Polyvinyl Amines

A preferred composition according to the present invention contains at least about 0.1%, preferably from about 0.1% to about 10%, more preferably from about 0.1% to about 5% by weight, of one or more polyvinyl amines charge boosters having the formula 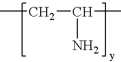
wherein y is from about 3 to about 10,000, preferably from about 10 to about 5,000, more preferably from about 20 to about 500. Polyvinyl amines suitable for use in the present invention are available from BASF under the name Lupasol® LU 321. The greater number of amine moieties per unit weight on the polyvinyl amines provides preferred substantial charge density.
I.c. Polyalkyleneimines

A preferred composition of the present invention comprises at least about 0.1%, preferably from about 0.1% to about 10%, more preferably from about 0.1% to about 5% by weight, of a polyalkyleneimine charge booster having the formula: 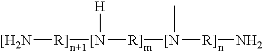
wherein the value of m is from 2 to about 700 and the value of n is from 0 to about 350. Preferably the compounds of the present invention comprise polyamines having a ratio of m:n that is at least 1:1 but may include linear polymers (n equal to 0) as well as a range as high as 10:1, preferably the ratio is 2:1. When the ratio of m:n is 2:1, the ratio of primary:secondary:tertary amine moieties of —RNH₂, —RNH, and —RN moieties, is 1:2:1. R can be C₂-C₈ alkylene, C₃-C₈ alkyl substituted alkylene, and mixtures thereof. Preferably R is ethylene, 1,2-propylene, 1,3-propylene, and mixtures thereof, and more preferably ethylene. R radicals serve to connect the amine nitrogens of the backbone.

Optionally, one or more of the polyvinyl amine backbone —NH₂ unit hydrogens can be substituted by an alkyleneoxy unit having the formula:
—(R₁O)_{X}R₂
wherein R₁ is C₂-C₄ alkylene; R₂ is hydrogen, C₁-C₄ alkyl, and mixtures thereof; and x is from 1 to 50. In one embodiment or the present invention the polyvinyl amine is reacted first with a substrate which places a 2-propyleneoxy unit directly on the nitrogen followed by reaction of one or more moles of ethylene oxide to form a unit having the general formula: 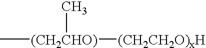
wherein x has the value of from 1 to about 50. Substitutions such as the above are represented by the abbreviated formula PO-EO.sub.X—. However, more than one propyleneoxy unit can be incorporated into the alkyleneoxy substituent.

The preferred polyamine cationic charge boosters of the present invention comprise backbones wherein less than about 50% of the R groups comprise more than 3 carbon atoms. The use of two and three carbon spacers as R moieties between nitrogen atoms in the backbone is advantageous for controlling the charge booster properties of the molecules. More preferred embodiments of the present invention comprise less than about 25% moieties having more than 3 carbon atoms. Yet more preferred backbones comprise less than about 10% moieties having more than 3 carbon atoms. Most preferred backbones comprise about 100% ethylene moieties.

The cationic charge boosting polyamines of the present invention comprise homogeneous or non-homogeneous polyamine backbones, preferably homogeneous backbones. For the purpose of the present invention the term “homogeneous polyamine backbone” is defined as a polyamine backbone having R units that are the same such as, all ethylene. However, this definition does not exclude polyamines that comprise other extraneous units comprising the polymer backbone that are present due to an artifact of the chosen method of chemical synthesis. For example, it is known to those skilled in the art that ethanolamine may be used as an “initiator” in the synthesis of polyethyleneimines, therefore a sample of polyethyleneimine that comprises one hydroxyethyl moiety resulting from the polymerization “initiator” would be considered to comprise a homogeneous polyamine backbone for the purposes of the present invention.

For the purposes of the present invention the term “non-homogeneous polymer backbone” refers to polyamine backbones that are a composite of one or more alkylene or substituted alkylene moieties, for example, ethylene and 1,2-propylene units taken together as R units.

However, not all of the suitable charge booster agents belonging to this category of polyamine comprise the above described polyamines. Other polyamines that comprise the backbone of the compounds of the present invention are generally polyalkyleneamines (PAAs), polyalkyleneimines (PAIs), preferably polyethyleneamine (PEAs), or polyethyleneimines (PEIs). Polyethyleneimines suitable for use in the present invention are available from BASF under the trade name Lupasol® such as Lupasol™ PR8515, having an average molecular weight of 1,800. A common polyalkyleneamine (PAA) is tetrabutylenepentamine. PEAs can be obtained by reactions involving ammonia and ethylene dichloride, followed by fractional distillation. The common PEAs obtained are triethylenetetramine (TETA) and tetraethylenepentamine (TEPA). Above the pentamines, such as, the hexamines, heptamines, octamines and possibly nonamines, the cogenerically derived mixture does not appear to separate by distillation and can include other materials such as cyclic amines and particularly piperazines.

I.d. Poly-Quaternary Ammonium Compounds

A preferred composition of the present invention comprises at least about 0.1%, preferably from about 0.1% to about 10%, more preferably from about 0.1% to about 5% by weight, of a cationic charge booster having the formula: 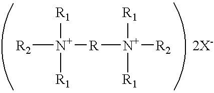
wherein R is substituted or unsubstituted C₂-C₁₂ alkylene, substituted or unsubstituted C₂-C₁₂ hydroxyalkylene; each R₁ is independently C₁-C₄ alkyl, each R₂ is independently C₁-C₂₂ alkyl, C₃-C₂₂ alkenyl, R₅-Q-(CH₂)ₘ—, wherein R₅ is C₁-C₂₂ alkyl, C₃-C₂₂ alkenyl, and mixtures thereof; m is from 1 to about 6; Q is a carbonyl unit as described above and mixtures thereof; X is an anion.

Preferably R is ethylene and R₁ is preferably methyl or ethyl, more preferably methyl. Preferably at least one R₂ is C₁-C₄ alkyl, more preferably methyl. Most preferably at least one R₂ is C₁₁-C₂₂ alkyl, C₁₁-C₂₂ alkenyl, and mixtures thereof.

Alternatively R₂ is a R₅-Q-(CH₂)ₘ— moiety wherein R₅ is an alkyl moiety having from 1 to 22 carbon atoms, preferably the alkyl moiety when taken together with the Q unit is an acyl unit derived from a source of triglyceride selected from the group consisting of tallow, partially hydrogenated tallow, lard, partially hydrogenated lard, vegetable oils, partially hydrogenated vegetable oils, such as, canola oil, safflower oil, peanut oil, sunflower oil, corn oil, soybean oil, tall oil, rice bran oil, and the like and mixtures thereof.

An example of a fabric softener cationic booster comprising a R₅-Q-(CH₂)ₘ— moiety has the formula: 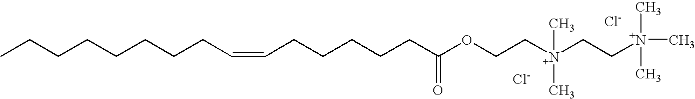
wherein R₁ is methyl, one of the R₂ units is methyl and the other of the R₂ unit is R₅-Q-(CH₂)ₘ— wherein R₅-Q- is an oleoyl unit and m is equal to 2. X is a softener compatible anion, such as an anion of a strong acid. For example, X can be chloride, bromide, methylsulfate, ethylsulfate, sulfate, nitrate and mixtures thereof. More preferably chloride and methyl sulfate.
II. Cationic Fabric Conditioning Agents

The carrier system of the present invention can comprise any of the cationic fabric conditioning agents known in the art. The fabric conditioning agents can include imidazolinium.

Conventional quaternary ammonium fabric conditioning agents useful for the present invention are: di dodecyl dimethyl ammonium bromide, di tetradecyl dimethyl ammonium chloride, di pentadecyl dimethyl ammonium chloride, di dodecyl diethyl ammonium chloride, di tetradecyl dipropyl ammonium chloride, di tallow dimethyl ammonium chloride, di tallow dimethyl ammonium methyl sulphate, di tallow diethyl ammonium chloride, di dodecyl diethyl ammonium chloride, di dodecyl diethyl ammonium acetate and di tallow dipropyl ammonium phosphate. Other useful cationic fabric conditioning agents are: dodecyl trimethyl ammonium bromide, tetradecyl trimethyl ammonium chloride, pentadecyl trimethyl ammonium chloride, cetyl trimethyl ammonium bromide, stearyl trimethyl ammonium bromide, tallow trimethyl ammonium chloride, eicosyl trimethyl ammonium chloride, dodecyl trimethyl ammonium methyl sulphate, tallow trimethyl ammonium acetate and tallow dimethyl benzyl ammonium chloride.

Other quaternary ammonium salt fabric conditioning compounds suitable for use are disclosed by Morton D. R. et al. in U.S. Pat. Nos. 3,686,025 and 6,083,899 are described in “Cationic Surfactants”, Surfactant Science series, Vol. 34, edited by Richmond J. M., Marcel Dekker Inc., 1990, which are incorporated herein by reference.

Preferred cationic fabric conditioning agents are dialkyl dimethyl ammonium chloride or alkyl trimethyl ammonium chloride wherein the alkyl contains from 12 to 20 carbon atoms and are derived from a long chain fatty acids, especially from hydrogenated tallow. The terms “tallow” and “tallowalkyl”, used herein, are intended to mean alkyls containing from 16 to 18 carbon atoms. The term “tallowalkoxy” used herein, means an alkyl ether radical wherein the alkyl contains from 16 to 18 carbon atoms. Specific examples of particularly preferred cationic conditioning agents include the following: tallowtrimethyl ammonium chloride; tallow dimethyl (3-tallowalkoxypropyl) ammonium chloride; ditallow dimethyl ammonium chloride; ditallow dimethyl ammonium methyl sulfate; eicosyltrimethyl ammonium chloride; dieicosydimethyl ammonium chloride; dodecyltrimethyl ammonium chloride; didodecyldimethyl ammonium chloride; tetradecyltrimethyl ammonium chloride; ditetradecyldimethyl ammonium chloride; pentadecyltrimethyl ammoaium chloride; dipentadecyltrimethyl ammonium chloride; didodecyldiethyl ammonium chloride; didodecyldipropyl ammonium chloride; ditetradecyldiethyl ammonium chloride; ditetradecyldipropyl ammonium chloride; ditallowdiethyl ammonium chloride; ditallowdipropyl ammonium chloride; tallowdimethyl benzyl ammonium chloride; tallowdiethyl benzyl ammonium chloride; dodecyltrimethyl ammonium methyl sulfate; didodecyldielbyl ammonium acetate; tallowtrimethyl ammonium acetate; tallowdimethyl benzyl ammonium nitrite; ditallowdipropyl ammonium phosphate; dodecyltrimethylammonium chloride, didodecyldimethylammonium methylsulfate; didodecyldipropylammonium ethylsulfate; ditallowdiethylammonium methylsulfate; ditallowdimethylammonium chloride; tallowdimethylbenzylammonium nitrate; ditallowdimethylammonium methylsulfate; ditallowdimethylammonium bisulfate; methyl(1)octadecylamidoethyl(2)octadecyl imidazolinium methylsulfate; methyl(1)dodecylamidoethyl(2)dodecyl imidazolinium chloride; tallowpyridinium methylsulfate; dodecylpyridinium chloride; dodecylmethylmorpholinium acetate; and tallowethylmorpholinium bromide.

The particularly preferred cationic fabric conditioning agents for the fragrance carrier of the present invention are: behenyltrimethylammonium chloride; ditallowdimethylammonium methylsulfate; ditallowdimethylammonium chloride; methyl(1)stearylamidoethyl(2) stearylimidazolinium methosulfate; methyl(1)stearylamidoethyl(2)stearylimidazolinium chloride; N,N-di(tallowyl-oxy-ethyl)-N,N-dimethyl ammonium chloride; N,N-di(canolyl-oxy-ethyl)-N,N-dimethyl ammonium chloride; N,N-di(tallowyl-oxy-ethyl)-N-methyl, N-(2-hydroxyethyl)ammonium chloride; N,N-di(canolyl-oxy-ethyl)-N-methyl, N-(2-hydroxyethyl)ammonium chloride; N,N-di(2-tallowyloxy-2-oxo-ethyl)-N,N-dimethyl ammonium chloride; N,N-di(2-canolyloxy-2-oxo-ethyl)-N,N-dimethyl ammonium chloride; N,N-di(2-tallowyloxyethylcarbonyloxyethyl)-N,N-dimethyl ammonium chloride; N,N-di(2-canolyloxyethylcarbonyloxyethyl)-N,N-dimethyl ammonium chloride; N-(2-tallowoyloxy-2-ethyl)-N-(2-tallowyloxy-2-oxo-ethyl)-N,N-dimethyl ammonium chloride; N-(2-canolyloxy-2-ethyl)-N-(2-canolyloxy-2-oxo-ethyl)-N,N-dimethyl ammonium chloride; N,N,N-tri(tallowyl-oxy-ethyl)-N-methyl ammonium chloride; N,N,N-tricanolyl-oxy-ethyl)-N-methyl ammonium chloride; N-(2-tallowyloxy-2-oxoethyl)-N-(tallowyl)-N,N-dimethyl ammonium chloride; N-(2-canolyloxy-2-oxoethyl)-N-(canolyl)-N,N-dimethyl ammonium chloride; 1,2-ditallowyloxy-3-N,N,N-trimethylammoniopropane chloride; and 1,2-dicanolyloxy-3-N,N,N-trimethylammoniopropane chloride; and mixtures of thereof.

Methyl-1-tallowamidoethyl-2-tallowimidazolinium methylsulfate available from Witco Chemical Company under the name Varisoft™ 475. Examples of monoalkyltrimethylammonium salts are monotallowtrimethylammonium chloride, mono(hydrogenated tallow)trimethylammonium chloride, palmityltrimethyl ammonium chloride and soyatrimethylammonium chloride, available from Witco Chemical Company under the names Adogen™ 471, Adogen™ 441, Adogen™ 444, and Adogen™ 415, respectively. Examples of behenyltrimethylammonium chloride are commercially available under the name Kemamine™ Q2803-C from Humko Chemical Division of Witco Chemical Corporation. Methylbis(tallowamidoethyl)(2-hydroxyethyl)ammonium methylsulfate and methylbis(hydrogenated tallowamidoethyl)(2-hydroxyethyl)ammonium methylsulfate; are available from Witco Chemical Company under the names Varisoft™ 222 and Varisoft™ 110, respectively: dimethylstearylbenzyl ammonium chloride sold under the names Varisoft™ SDC by Witco Chemical Company and Ammonyx™ 490 by Onyx Chemical Company.

The most preferred quaternary ammonium salt fabric conditioning agents are methyl bis(hydrogenated ditallowamidoethyl) 2 hydroxyethyl ammonium chloride, commercially available from Croda Inc. under the name INCROSOFT® 100; methyl bis(hydrogenated tallow amidoethyl)-2-hydroxyethyl ammonium methyl sulfate, commercially available from the Stepan Company under the name ACCOSOFT® 440-75 DEG; methyl (1) hydrogenated tallow amidoethyl (2) hydrogenated tallow imidazolinium methyl sulfate, commercially available from the Stepan Company under the name ACCOSOFT® 808 HT; behenyltrimethylammonium chloride, commercially available under the trade name Kemamine™ Q2803-C from Humko Chemical Division of Witco Chemical Corporation.

III. Matrix Materials

The matrix materials for forming the particles of the carrier system of the present invention comprise any substantially water-insoluble polymers and copolymers compatible with and miscible with the fragrance used in the present invention and harmless or beneficial to the fabrics when dispersed and melted on to them. Examples of suitable hydrophobic polymers and copolymer for use as the matrix material include polyethylene homopolymers A-C® 1702; A-C® 617, A-C® 617A, and A-C® 15, commercially available from AlliedSignal Inc.; PERFORMALENE™ PL available from Baker Pertolite Co.; polyethylene homopolymer commercially available from New Phase Technologies; ETHYLENE-ACRYLIC ACID COPOLYMERS A-C® 540, A-C® 540A, and A-C® 580 commercially available from AlliedSignal Inc.; polyamides having a molecular weight in the range of from about 6,000 up to about 12,000, for example, MACROMELT™ 6030 manufactured by the Henkel Ag. of Dusseldorf, Germany; VERSALON™ 1135 polyamide polymer available commercially from General Mills, Inc.; polyethylene-vinyl acetate copolymers; silicon copolymer modified waxes, for example; candelilla/silicon copolymer, ozokerite/silicon copolymer (SP 490 and SP 1026), and other silicon copolymer modified natural and synthetic waxes, commercially available from Strahl & Pitsch Inc., reaction products of silicon copolymers with synthetic and natural waxes, for example siliconyl candelilla, and siliconyl synthetic paraffin LMS, commercially available from Koster Keunen Inc. Synthetic and natural waxes can also be utilized as hydrophobic materials for the carrier system of the present invention.

Alternatively, the matrix materials can be formed suitable nontoxic, pharmaceutical solid core materials of inert hydrophobic biocompatible materials with a melting range between about 40° C. and about 100° C. Examples are natural, regenerated, or synthetic waxes including: animal waxes, such as beeswax; lanolin and shellac wax; vegetable waxes such as camauba, candelilla, cutina, sugar cane, rice bran, and bayberry wax; mineral waxes such as petroleum waxes including paraffin and microcrystalline wax; and mixtures thereof. Other hydrophobic compounds which may be used include fatty acid esters such as ethyl stearate, isopropyl myristate, and isopropyl palmitate; high molecular weight fatty alcohols such as cetostearyl alcohol, cetyl alcohol, stearyl alcohol, and oleyl alcohol; solid hydrogenated castor and vegetable oils; hard paraffins; hard fats; and mixtures thereof. Other hydrophobic compounds which may be used in the present invention include triglycerides, preferably of food grade purity or better, which may be produced by synthesis or by isolation from natural sources. Natural sources may include animal fat or vegetable oil, such as, soy oil, a source of long chain triglycerides (LCT). Other suitable triglycerides are composed predominantly of medium length fatty acids (C10-C18), denoted medium chain triglycerides (MCT). The fatty acid moieties of such triglycerides can be unsaturated, monounsaturated or polyunsaturated. Mixtures of triglycerides having various fatty acid moieties are also useful for the present invention. The core can comprise a single hydrophobic compound or a mixture of hydrophobic compounds. Hydrophobic materials are known to those skilled in the art and are commercially available, as described in the list of suitable carrier materials in Martindale, The Extra Pharmacopoeia, The Pharmaceutical Press, 28th Edition pp 1063-1072 (1982).

It is preferred that the particles used in the present invention have a melting point in the range from about 60° C. to about 150° C., preferably from about 80° C. to about 100° C. The melting point of the particles is usually a function of the carrier matrix employed. Accordingly, preferred matrix materials have a melting point in the range of about 60° C. to about 150° C., preferably from about 80° C. to about 100° C. It should be understood that it is the melting point of the particle rather than of the carrier matrix that is important for use of the carrier system of the present invention. Considerations in the selection of the matrix material include good barrier properties to the active agents and the fragrance ingredients, low toxicity and irritancy, stability, and high loading capacity for the active agents of interest.

IV. Fragrances

Preferably, a fragrance is included in the carrier system of the present invention. The fragrance that can be encapsulated in the carrier system of the present invention, can be any odoriferous material and can be selected according to the desires of the fragrance creator. In general terms, such fragrance materials are characterized by a vapor pressure below atmospheric pressure at ambient temperatures. The high boiling perfume materials employed herein will most often be solids at ambient temperatures, but also can include high boiling liquids. A wide variety of chemicals are known for perfumery uses, including materials such as aldehydes, ketones, esters, and the like. More commonly, naturally occurring plant and animal oils and exudates comprising complex mixtures of various chemical components are known for use as fragrances, and such materials can be used herein. Fragrances useful for the present invention can be a single aroma chemical, relatively simple in their composition, or can comprise highly sophisticated, complex mixtures of natural and synthetic chemical components, all chosen to provide any desired odor.

Suitable fragrance which can be used in the present invention comprise, for example the high boiling components of woody/earthy bases containing exotic materials such as sandalwood oil, civet, patchouli oil, and the like. The perfumes herein can be of a light, floral fragrance, such as for example, high boiling components of rose extract, violet extract, and the like. The perfumes herein can be formulated to provide desirable fruity odors, such as for example lime, lemon, orange, and the like. The perfume can be any material of appropriate chemical and physical properties which exudes a pleasant or otherwise desirable odor when applied to fabrics. Perfume materials suitable for use in the present invention are described more fully in S. Arctander, Perfume Flavors and Chemicals, Vols. I and II, Aurthor, Montclair, N.J., and the Merck Index, 8th Edition, Merck & Co., Inc. Rahway, N.J., both references being incorporated herein by reference.

V. Processing Method

The carrier particles of the present invention can be prepared by co-melting the active agent, such as a fragrance with the matrix materials, cationic charge boosters, and optionally cationic fabric conditioning agents and then converting the molten mass into particles of the desired size by any of the conventional means for converting melted materials to dry particles, such as, by spraying the mass through a nozzle into a cool atmosphere. Particle size selection can be accomplished by screening, airstream segregation, and the like.

The process for producing the fragrance carrier particles comprises the following stages:
(i) heating the matrix materials, such as solid hydrophobic polymers and co-polymers, cationic charge boosters, and optionally cationic fabric softening agents to about 10 degrees above the melting point of the ingredients, with continuous agitation;
(ii) adding the fragrance to the melt with continuous agitation; and
(iii) cooling the melt to ambient temperature to form a dry free-flowing powder composition.

The molten mixture can be converted into a free-flowing powder by spraying processes known in the art, such as spray chilling, spray-congealing, granulation, and the like to create fine or very fine particles, of a substantially spherical shape, having an average particle diameter of from about 1 microns to about 500 microns, or more preferably having an average particle diameter of from about 50 microns to about 200 microns.

Spraying processes are particularly suitable in which the melts are converted into fine or very fine particles, primarily of spherical shape, whilst they are finely divided and in free fall. The spraying processes can be assisted by blowing with countercurrent cold air such as by spray-chilling, spray-congealing. Other conventional processes which result in coarse particles are also suitable for producing the fragrance carrier particles according to the invention. The processes include, for example, a process in which the melt is discharged on to a cooled roll or cooling belt, and where the mixture is obtained as a pellet in the shape of a drop or as a chip after the melt has solidified.

A flow agent is preferably added after the powder is manufactured. Flow agents which can be used in the present invention can be silica, clay, starch, and the like which can be added to the fragrance-carrier particles. Suitable fine silica materials are commercially available as pyrogenic or fumed silicas, such as materials sold under Trade names of Cabosil manufactured by G. L. Cabot Inc., Aerogel 500 manufactured by J. M. Huber Corp., Syloid 244, -63, -65 manufactured by W. R. Grace and Co., Li-sil 233 manufactured by Pittsburg Plate Glass Co., and Sipemat D-17 manufactured by Degussa Co. Suitable clay materials include kaolinites and bentonites, as described in British Patent No. 1,460,646. Preferred are smectite clays described in British Patent No. 1,400,898, which have textile softening properties. These are three layer, expandable, clays, such as nontronite, saponite and montmorillonite, volchonskoite, hectorite and sauconite. For example, suitable clay materials are available as Thixogel No. 1 and Gelwhite GP and Soft Dark from Georgia Kaolin Co.; Vollay BC and Volclay No. 325 from American Colloid Co., and Veegum Pro and Veegum F. from T. R. Venderbilt.

Spray chilling, or spray congealing is well known in the art and been used commercially in many applications, including foods where the core material is a flavoring oil and cosmetics where the core material is a fragrance oil, see “Flavor Encapsulation”, edited by Risch S. J. and Reineccius G. A., ACS Symposium Series, 1988; “Multiparticulate Oral Drug Delivery” pp.17-34, edited by Ghebre-Sellassie I., Drugs and the Pharmaceutical Sciences, Vol. 65, 1994 which are incorporated herein as references.

The processing method described herein is simple and economical and is characterized by high loading, reproducibility, versatility, and stability. The method is further illustrated in the non-limiting examples.

The particles may diffuse at any of the rates of the following:
(i) at steady-state or zero-order release rate in which there is substantially continuous releaser per unit of time;
(ii) a first-order release rate in which the rate of release declines toward zero with time; and
(iii) a delayed release in which the initial rate is slow, but then increases with time. The active agent contained in the particles can be released an extended period of time up to a period of three weeks. Alternatively, the active agent of the particles is released upon heat treatment of the particles to substantially the melting point of the particles, such as by ironing a fabric having carrier system and adhere thereto.
   VI. Particle Adhesion onto Fabric

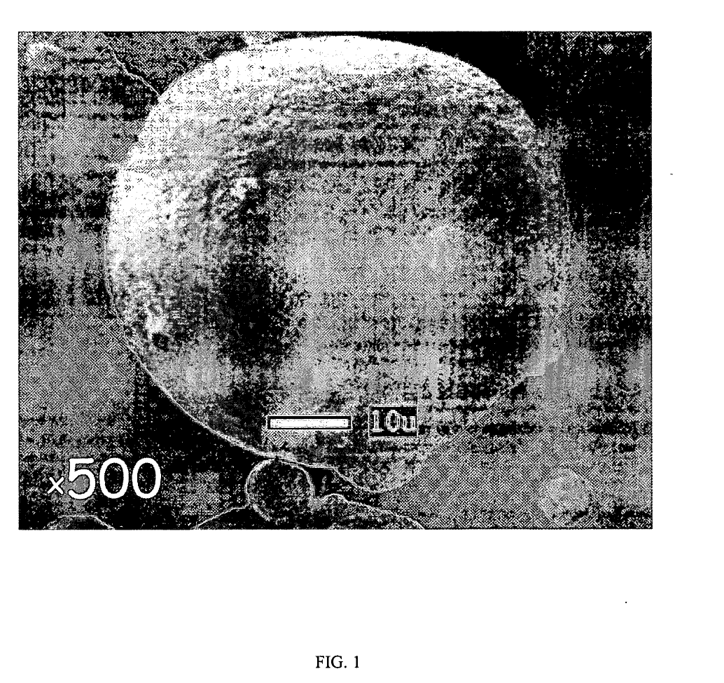

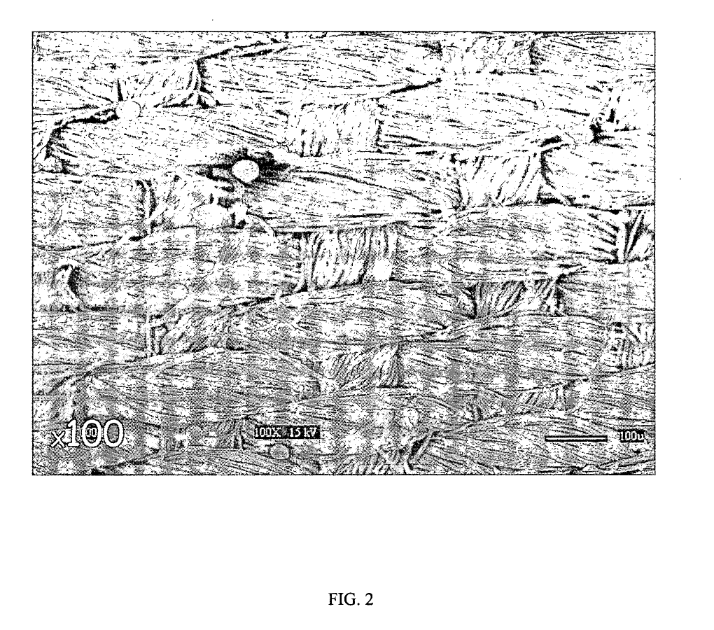

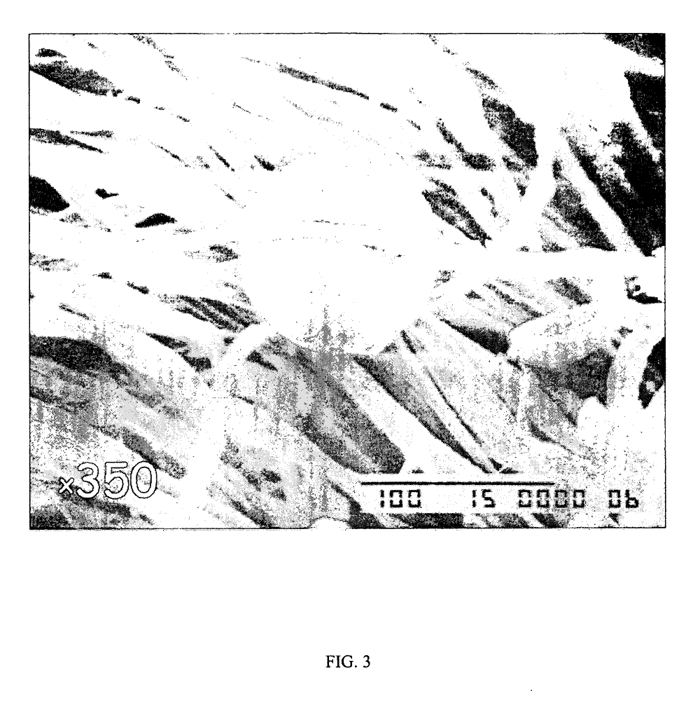

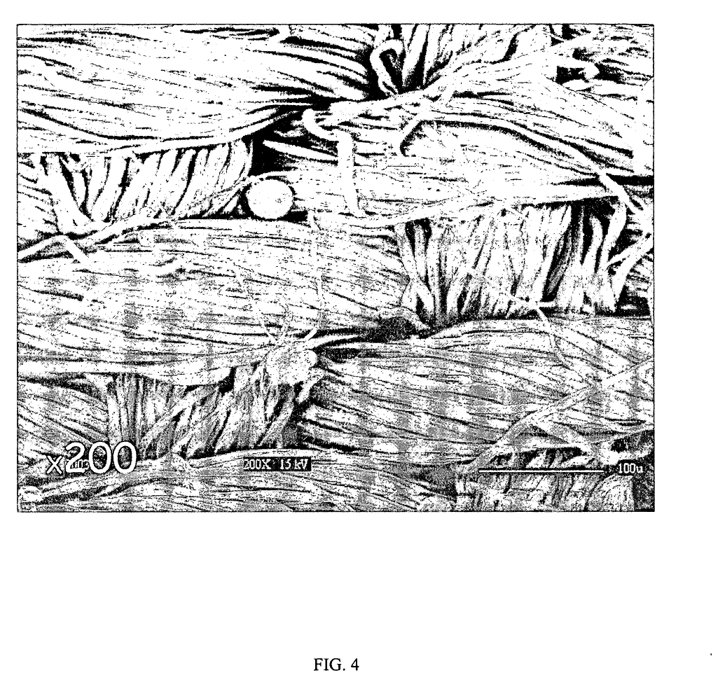

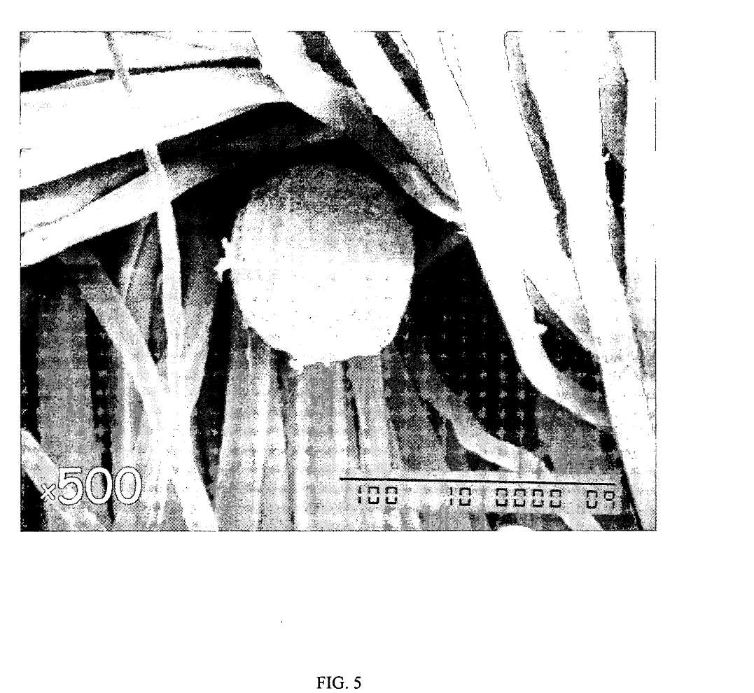

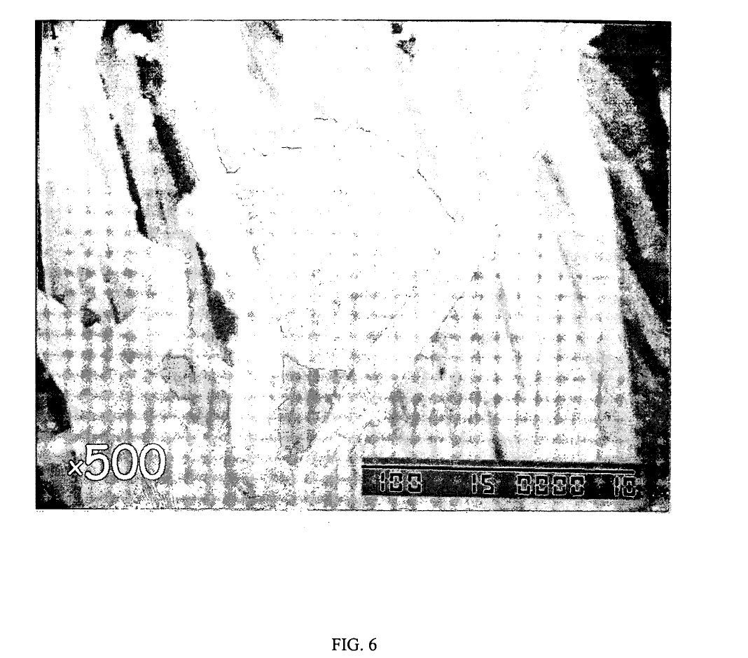

The shape and size of the fragrance-carrier particles of the present invention was verified by examining the samples under a scanning electron microscope (SEM). FIG. 1 shows a SEM image magnified at 500 times indicating the particles are spherical and smooth in nature with an average particle size ranging between about 50 microns to about 100 microns. The substantivity of the fragrance-carrier particles of Example 2 onto fabric, from a fabric conditioner application is shown in FIG. 2 and in FIG. 3. FIG. 2 shows a SEM magnified 100 times of fabric (towels) washed with a fabric softener comprising the fabric carrier particles formed in Example 2. FIG. 3 shows a SEM magnified 350 times of fabric (towels) washed with a fabric softener comprising the fabric carrier particles formed in Example 2. The substantivity of the fragrance-carrier particles of Example 2 onto fabric, from a powder laundry detergent application is shown in FIG. 4 and FIG. 5. 4 shows a SEM magnified 200 times of a fabric (towels) washed with a powder laundry detergent comprising the fabric carrier particles formed in Example 2. FIG. 5 shows a SEM magnified 500 times of a fabric (towels) washed with a powder laundry detergent comprising the fabric carrier particles formed in Example 2. The substantivity of the fragrance-carrier particles of Example 2 onto fabric, from a liquid laundry detergent application is shown in FIG. 6. FIG. 6 is a SEM magnified 500 times of a fabric (towels) washed with a liquid detergent comprising the fabric carrier particles of Example 2.

The invention can be further illustrated by the following examples thereof, although it will be understood that these examples are included merely for purposes of illustration and are not intended to limit the scope of the invention unless otherwise specifically indicated. All percentages, ratios, and parts herein, in the Specification, Examples, and Claims, are by weight and are approximations unless otherwise stated.

### Sample Preparation

### EXAMPLE 1

The fragrance used in the following Examples 1-5 is a fragrance composition that is not substantive on fabric when used as neat oil. The fragrance composition used is as follows:

| Perfume Composition | Component (% Wt.) |
|---|---|
| Geraniol | 30.0 |
| Dihydro Myrcenol | 20.0 |
| Phenyl Ethyl Alcohol | 5.0 |
| Linalool | 25.0 |
| Tetrahydro Linalyl Acetate | 20.0 |

Fragrance carrier particles were formed having the following composition;
40% Hydrophobic polymer of polyethylene homopolymer, commercially available from AlliedSignal Inc. as PERFORMALENE™ PL
29% Cationic fabric conditioning agent of methyl bis(hydrogenated ditallowamidoethyl) 2 hydroxyethyl ammonium chloride, commercially available from Croda Inc. as INCROSOFT 100
1% Cationic charge booster of polyethyleneimine having an average molecular weight of 1800, commercially available from BASF Corporation as LUPASOL™ PR815 30% Fragrance.

The hydrophobic polymer, cationic fabric conditioning agent, and cationic charge booster were melted together to form a clear solution at 90° C. The fragrance was added to the molten mixture while mixing it with a propeller mixer. This molten solution is atomized into a chamber with ambient temperature air passing through the chamber. The atomized droplets freeze into solid particles in the size range of about 20 microns to about 150 microns.

### EXAMPLE 2

Fragrance carrier particles were formed having the following composition;
40% Hydrophobic copolymer of a silicon copolymer modified candelilla wax commercially available from Strahl & Pitsch Inc.
29% Cationic fabric conditioning agent of methyl bis(hydrogenated ditallowamidoethyl) 2 hydroxyethyl ammonium chloride, commercially available from Croda Inc. as INCROSOFT 100
1% Cationic charge booster of polyethyleneimine having an average molecular weight of 1800, commercially available from BASF Corporation as LUPASOL™ PR815 30% Fragrance.

The hydrophobic polymer, cationic fabric conditioning agent, and cationic charge booster were melted together to form a clear solution at 90° C. The fragrance was added to the molten mixture while mixing it with a propeller mixer. This molten solution is atomized into a chamber with ambient temperature air passing through the chamber. The atomized droplets freeze into solid particles in the size range of about 20 microns to about 150 microns.

### EXAMPLE 3

Fragrance carrier particles were formed having the following composition;
40% Hydrophobic polymer of ethylene acrylic acid copolymer, commercially available from AlliedSignal Inc. as ETHYLENE-ACRILIC ACID COPOLYMERS A-C® 540,
29% Cationic fabric conditioning agent of methyl bis(hydrogenated tallow amidoethyl)-2-hydroxyethyl ammonium methyl sulfate, commercially available from the Stepan Company as ACCOSOFT® 440-75 DEG
1% Cationic charge booster of polyethyleneimine having an average molecular weight of 1800, commercially available from BASF Corporation as LUPASOL™ PR815 30% Geraniol.

The hydrophobic polymer, cationic fabric conditioning agent, and cationic charge booster were melted together to form a clear solution at 90° C. The fragrance was added to the molten mixture while mixing it with a propeller mixer. This molten solution is atomized into a chamber with ambient temperature air passing through the chamber. The atomized droplets freeze into solid particles in the size range of about 20 microns to about 150 microns.

### Test Methods

Twenty cotton towels having the following dimensions 14″×17″ were used for evaluating the performance of the fragrance carrier particles of the present invention. Ten of the towels were 100% cotton and ten were composed of a mixture of 65% polyester and 35% cotton. The fabric was laundered in an American washing machine Kenmore™ 90 series.

Wash Conditions:
Fabric Load: 20 towels
Laundry detergent sample size: 100 grams
Fabric softener sample size: 30 grams
Dosing into the machine: Laundry detergent was dosed directly into the machine Fabric softener was placed in the dispenser
Water level: Small Load
Water temperature: Cold/Cold
Cycle: Short cycle
Water temperature: Cold/Cold
Rinse options: One rinse cycle
Speeds: Heavy duty

The laundered fabric was line dried overnight in a fragrance free room. The dry fabric was folded into two and placed into an aluminum tray, approximately 5 cm deep, covered with a perforated aluminum sheet, in order to keep it out of view, up to the moment of the sniff-test. The sniff-test was performed on the dry laundered fabric in a “pre-ventilated” room by ten graders, 24 hours following wash. The laundered fabric was then covered with a perforated aluminum sheet, and was evaluated again after one week and two weeks by a sniff-test method.

Odor perception is, by its nature, a very subjective determination. According to the procedure, the samples to be tested are provided to a panel of ten odor specialists who independently rank odor intensity of the dry laundered fabric using a scale of 1 (no perceived odor) to 10 (high odor intensity). Samples yielding an odor ranking below about 2 possess an odor which would hardly be noticed by the general public.

### EXAMPLE 4

The performance of a fabric softener product comprising the fragrance carrier particles of Example 2 (i.e., the ability to increase fragrance deposition onto fabric, as well as the ability to prolong fragrance release from the dry laundered fabric over an extended period of time, or yield a high impact fragrance “burst” upon ironing the fabric) was evaluated and compared to the performance of the same fabric softener product comprising the neat fragrance, at the same fragrance level. The unfragranced fabric softener base was a commercial DOWNY™ FREE fabric softener product available from Procter & Gamble Company of Cincinnati, Ohio that is fragrance free.

The laundry samples were prepared at a 1% effective fragrance concentration using the fragrance described in Example 1. The control sample was prepared by weighting into a jar 1 gram of the neat fragrance and 99 grams of the DOWNY™ FREE unfragranced base and the resulting mixture was mixed for one hour using a magnetic stirrer. The fabric softener comprising the fragrance particles of the present invention was prepared by weighting into a jar 3.3 grams of the fragrance particles of Example 2 and 96.7 grams of the DOWNY™ FREE unfragranced base and the resulting mixture was mixed for one hour using a magnetic stirrer.

Twenty towels were placed in the washing machine (10 of the towels used were 100% cotton and the other 10 towels were 65% polyester and 35% cotton) with 100 grams of TIDE™ FREE powder detergent dosed directly into the washing machine and 30 grams of fabric softener sample was placed in the fabric softener dispenser.

The following washing machine cycle was used:
Fabric Load: 20 towels
Laundry detergent sample size: 100 grams
Fabric softener sample size: 30 grams
Dosing into the machine: Laundry detergent was dosed directly into the machine Fabric softener was placed in the dispenser
Water level: Small Load
Water temperature: Cold/Cold
Cycle: Short cycle
Water temperature: Cold/Cold
Rinse options: One rinse cycle
Speeds: Heavy duty

Cloth samples were line-dried for 24 hours and then evaluated at four stages: immediately after drying (24 hours following wash); upon ironing 24 hours following wash; at one week after drying; and at two weeks after drying. The dry fabric was folded into two and placed into an aluminum tray, approximately 5 cm deep, covered with a perforated aluminum sheet, between the evaluation stages, up to the moment of the sniff-test. The sniff-test was performed on the dry laundered fabric in a “pre-ventilated” room by ten graders, and test results are presented below:

24 Hours Following Wash

| Sample | Dry Fabric | Upon Ironing |
|---|---|---|
| Neat Fragrance (Control) | 4 | 5 |
| Fragrance Particle (Example 2) | 7 | 9 |

Test results indicate that the cloth samples washed with the fragrance particles of Example 2 are significantly more intense than the control samples washed with the neat fragrance immediately after drying (24 hours following wash).

A significant increase in fragrance intensity was observed upon ironing the fabric laundered with the fragrance particles of Example 2. Although odor intensity of the fabric laundered with the neat fragrance (control) was observed to be directly more intense, upon ironing, no significant increase in odor intensity was observed. Only a slight increase in odor intensity was observed when ironing the fabric laundered with the neat fragrance (control).

| Sample | One Week | Two Weeks |
|---|---|---|
| Neat Fragrance (Control) | 3 | 2 |
| Fragrance Particle (Example 2) | 6 | 5 |

At week one and week two the test results indicate that the cloth samples washed with the fragrance particles of Example 2 are significantly more intense than the control samples washed with the neat fragrance (control). No significant difference in odor intensity was observed between the 100% cotton towels and the towels composed of 65% polyester and 35% cotton. The products comprising the fragrance particles show significant improvement over the performance of the neat fragrance in sustaining the volatile constituents of the fragrance and providing a prolong fragrance release from the dry laundered fabric over an extended period of time.

It is understood that the above-described embodiments are illustrative of only a few of the many possible specific embodiments which can represent applications of the principles of the invention. Numerous and varied other arrangements can be readily derived in accordance with these principles by those skilled in the art without departing from the spirit and scope of the invention.

### EXAMPLE 5

The performance of a powder laundry detergent product comprising the fragrance carrier particles of Example 2 (i.e., the ability to increase fragrance deposition onto fabric, as well as the ability to prolong fragrance release from the dry laundered fabric over an extended period of time, or yield a high impact fragrance “burst” upon ironing the fabric) was evaluated and compared to the performance of the same fabric softener product comprising the neat fragrance, at the same fragrance level. The unfragranced powder laundry detergent base was a commercial TIDE™ FREE powder laundry detergent available from Procter & Gamble Company of Cincinnati, Ohio that is fragrance free.

The laundry samples were prepared at a 1% effective fragrance concentration using the fragrance described in Example 1. The control sample was prepared by weighting into a jar 1 gram of the neat fragrance and 99 grams of the TIDE™ FREE unfragranced and the resulting mixture was mixed for about one hour. The powder laundry detergent comprising the fragrance particles of the present invention was prepared by weighting into a jar 3.3 grams of the fragrance particles of Example 2 and 96.7 grams of the TIDE™ FREE unfragranced powder laundry detergent base and the resulting mixture was mixed for about one hour.

Twenty towels were placed in the washing machine (10 of the towels used were 100% cotton and the other 10 towels were 65% polyester and 35% cotton) with 100 grams of powder laundry detergent dosed directly into the washing machine.

The following washing machine cycle was used:
Fabric Load: 20 towels
Laundry detergent sample size: 100 grams
Dosing into the machine: Laundry detergent was dosed directly into the machine
Water level: Small Load
Water temperature: Cold/Cold
Cycle: Short cycle
Water temperature: Cold/Cold
Rinse options: One rinse cycle
Speeds: Heavy duty

Cloth samples were line-dried for 24 hours and then evaluated at four stages: immediately after drying (24 hours following wash); upon ironing 24 hours following wash; at one week after drying; and at two weeks after drying. The dry fabric was folded into two and placed into an aluminum tray, approximately 5 cm deep, covered with a perforated aluminum sheet, between the evaluation stages, up to the moment of the sniff-test. The sniff-test was performed on the dry laundered fabric in a “pre-ventilated” room by ten graders, and test results are presented below:

24 Hours Following Wash

| Sample | Dry Fabric | Upon Ironing |
|---|---|---|
| Neat Fragrance (Control) | 3 | 5 |
| Fragrance Particle (Example 2) | 6 | 8 |

Test results indicate that the cloth samples washed with the fragrance particles of Example 2 are significantly more intense than the control samples washed with the neat fragrance immediately after drying (24 hours following wash).

A significant increase in fragrance intensity was observed upon ironing the fabric laundered with the fragrance particles of Example 2. Although odor intensity of the fabric laundered with the neat fragrance (control) was observed to be directly more intense, upon ironing, no significant increase in odor intensity was observed. Only a slight increase in odor intensity was observed when ironing the fabric laundered with the neat fragrance (control).

| Sample | One Week | Two Weeks |
|---|---|---|
| Neat Fragrance (Control) | 2 | 1 |
| Fragrance Particle (Example 2) | 5 | 4 |

At week one and week two the test results indicate that the cloth samples washed with the fragrance particles of Example 2 are significantly more intense than the control samples washed with the neat fragrance (control). The products comprising the fragrance particles show significant improvement over the performance of the neat fragrance in sustaining the volatile constituents of the fragrance and providing a prolong fragrance release from the dry laundered fabric over an extended period of time.

### EXAMPLE 6

Fragrance carrier particles can be formed having the following composition:
69% Hydrophobic copolymer of a silicon copolymer modified candelilla wax commercially available from Strahl & Pitsch Inc.
1% Cationic charge booster of polyethyleneimine having an average molecular weight of 1800, commercially available from BASF Corporation as LUPASOL® PR815 and
30% Fragrance.

The hydrophobic polymer and cationic charge booster can be melted together to form a clear solution at 90° C. The fragrance can be added to the molten mixture while mixing it with a propeller mixer. This molten solution is atomized into a chamber with ambient temperature air passing through the chamber. The atomized droplets freeze into solid particles in the size range of about 20 microns to about 150 microns.

### EXAMPLE 7

An acidic hard surface cleaner can be formed comprising the fragrance carrier particles of Example 6 as follows:

| | Weight % |
|---|---|
| Citric Acid (50% solution) | 12.0 |
| C12-15 linear alcohol ethoxylate with 3 moles of EO | 5.0 |
| Alkylbenzene sulfonic acid | 3.0 |
| Fragrance carrier particles | 2.0 |
| Water | 78.0 |

### EXAMPLE 8

A basic hard surface cleaner can be formed comprising the fragrance carrier particles of Example 6 as follows:

| | Weight % |
|---|---|
| Sodium tripolyphosphate | 2.0 |
| Sodium silicate | 1.9 |
| NaOH (50% solution) | 0.1 |
| Dipropylene glycol monomethyl ether | 5.0 |
| Octyl polyethoxyethanol, 12-13 moles EO | 1.0 |
| Fragrance carrier particles | 2.0 |
| Water | 88.0 |

### EXAMPLE 9

An automatic dishwashing powder can be formed comprising the fragrance carrier particles of Example 6 as follows:

| | Weight % |
|---|---|
| Sodium tripolyphosphate | 25.0 |
| Sodium carbonate | 25.0 |
| C12-15 linear alcohol ethoxylate with 7 moles of EO | 3.0 |
| Fragrance carrier particles | 2.0 |
| Sodium sulfate | 45.0 |

### EXAMPLE 10

A powdered carpet cleaner can be formed comprising the fragrance carrier particles of Example 6 as follows:

| | Weight % |
|---|---|
| Sodium bicarbonate | 20.0 |
| Benzyl benzoate | 5.0 |
| Amorphous silica | 5.0 |
| Fragrance carrier particles | 2.0 |
| Sodium sulfate | 68.0 |

### EXAMPLE 11

A carpet shampoo can be formed comprising the fragrance carrier particles of Example 6 as follows:

| | Weight % |
|---|---|
| C 13-15 alcohol alkoxylate EO/PO copolymer | 3.5 |
| Nitrilotriacetic acid Na₃ (40%) | 2.0 |
| Sodium tripolyphosphate | 6.0 |
| Sodium silicate | 4.0 |
| Amphoteric surfactant, low foam | 5.5 |
| Fragrance carrier particles | 2.0 |
| Water | 77.0 |

### EXAMPLE 12

A spray furniture polish can be formed comprising the fragrance carrier particles of Example 6 as follows:

| | Weight % |
|---|---|
| Paraffin oil | 18.0 |
| Silicone oil | 3.5 |
| Sorbitan monooleate emulsifier | 1.0 |
| Carnauba wax | 1.0 |
| Beeswax | 0.5 |
| Fragrance carrier particles | 2.0 |
| Water | 74.0 |

### EXAMPLE 13

A powder toilet cleaner can be formed comprising the fragrance carrier particles of Example 6 as follows:

| | Weight % |
|---|---|
| Sodium carbonate | 10.0 |
| Sodium chloride | 4.0 |
| Linear alkylbenzene sulfonate | 0.5 |
| Fragrance carrier particles | 2.0 |
| Sodium hydrogen sulfate | 83.5 |

### EXAMPLE 14

A hand dishwashing liquid can be formed comprising the fragrance carrier particles of Example 6 as follows:

| | Weight % |
|---|---|
| Amido-sulfonate surfactant | 25.0 |
| Fragrance carrier particles | 2.0 |
| Water | 73.0 |

### EXAMPLE 15

A glass cleaner can be formed comprising the fragrance carrier particles of Example 6 as follows:

| | Weight % |
|---|---|
| Alcohol alkoxylate surfactant | 0.2 |
| Isopropanol | 10.0 |
| Ammonia liquor (28%) | 3.0 |
| Fragrance carrier particles | 2.0 |
| Water | 84.8 |

### EXAMPLE 16

A tile cleaner can be formed comprising the fragrance carrier particles of Example 6 as follows:

| | Weight % |
|---|---|
| Tetrasodium EDTA (40%) | 10.0 |
| Sodium carbonate | 4.0 |
| Amphoteric surfactant | 3.0 |
| Fragrance carrier particles | 2.0 |
| Water | 81.0 |

### EXAMPLE 17

A foaming bathroom cleaner can be formed comprising the fragrance carrier particles of Example 6 as follows:

| | Weight % |
|---|---|
| Alpha olefin sulfonates | 3.0 |
| Fatty acid alkanol amides | 3.0 |
| Isopropanol | 10.0 |
| Sodium EDTA | 3.0 |
| Fragrance carrier particles | 2.0 |
| Water | 79.0 |

### EXAMPLE 18

A room deodorizer can be formed comprising the fragrance carrier particles of Example 6 as follows:

| | Weight % |
|---|---|
| Paraffinic solvent | 6.0 |
| Fragrance carrier particles | 2.0 |
| Soyethyl morpholinium ethosulfate deodorizer | 1.0 |
| Emulsifiers | 0.5 |
| Triethanolamine | 0.2 |
| Water | 90.3 |

### EXAMPLE 19

The particles of the present invention can be incorporated into an animal litter to provide a long lasting fragrance to the product.

An animal litter product can be formed comprising the fragrance carrier particles of Example 6 as follows:

| | Weight % |
|---|---|
| Soyethyl morpholinium ethosulfate deodorizer | 1.0 |
| Fragrance carrier particles | 2.0 |
| Sodium bentonite clay | 97.0 |

### EXAMPLE 20

The particles of the present invention can be incorporated into a wipe.

The wipe can be formed by spraying the wipe with the fragrance carrier particles of the suspension of Example 2.

### EXAMPLE 21

The particles of the present invention can be incorporated into a wipe.

The wipe can be formed by incorporating the fragrance carrier particles of Example 8 between layers of the wipe.

1. A solid particle for use as a controlled delivery system for a household product:
said solid particle further comprising an active agent and a cationic charge booster, said solid particle being formed of a hydrophobic polymer, hydrophobic copolymer, or a mixture thereof.

2. The system of claim 1 wherein said solid particle has a melting point between about 60° C. to about 150° C.

3. The system of claim 1 wherein said hydrophobic polymer or hydrophobic copolymer is selected from a group consisting of: polyethylene homopolymers; ethylene-acrylic acid copolymer; polyamide polymer having a molecular weight in the range of from about 6,000 up to about 12,000; polyethylene-vinyl acetate copolymer; silicon synthetic wax copolymer; silicon natural wax copolymer; candelilla silicon copolymer, ozokerite silicon copolymer; siliconyl candelilla copolymer; and siliconyl synthetic paraffin copolymer.

4. The system of claim 1 wherein said hydrophobic polymer comprises polyethylene.

5. The system of claim 1 wherein said hydrophobic material is selected from the group consisting of natural waxes, synthetic waxes, fatty acid esters, fatty alcohols, solid hydrogenated plant oils, biodegradable natural polymers and synthetic polymers.

6. The controlled release system of claim 1 where said solid particle has an average particle diameter of about from 1 micron to about 500 microns.

7. The system of claim 8 wherein said average particle diameter is from about 50 microns to about 200 microns.

8. The system of claim 1 wherein said cationic charge booster is selected from the group consisting of a quaternary ammonium compound, polyvinyl amine, polyalkyleneimine, and a poly-quaternary ammonium compound.

9. The system of claim 1 wherein said cationic charge booster comprises polyethyleneimine, having an average molecular weight of 1,800.

10. The system of claim 1 wherein said active agent comprises a fragrance.

11. The system of claim 1 wherein said hydrophobic polymer, hydrophobic copolymer or mixture thereof is present in an amount of about 1% to about 95% by weight said cationic charge booster is present in an amount of about 0.1% to about 10% by weight and said fragrance is present in an amount of about 1.0% to about 50% by weight.

12. The system of claim 1 wherein said solid particle releases said active agent over an extended period of time.

13. The system of claim 12 wherein said extended period of time is up to about 3 weeks.

14. The system of claim 1 wherein said controlled release system is in the form of a dry, free-flowing powder composition.

15. A household product comprising said system of claim 1.

16. The household product of claim 15 wherein said household product is selected from the group consisting of dishwashing detergent, surface cleaner, deodorizer, animal litter and cleaning wipe.

17. The household product of claim 16 wherein said dishwashing detergent is selected from the group consisting of an automatic dishwashing detergent powder, an automatic dishwashing detergent liquid and a hand dishwashing detergent.

18. The household product of claim 16 wherein said surface cleaner is selected from the group consisting of acid hard surface cleaner, basic hard surface cleaner, tile cleaner, glass cleaner, bathroom surface cleaner, furniture polish, carpet powder cleaner, carpet shampoo, automotive cleaner, automotive wax and automotive polish.

19. The household product of claim 16 wherein said household product is a cleaning wipe, said cleaning wipe comprising one or more layers of a material.

20. The household product of claim 19 wherein said solid particles are adhered to said one or more layers of material.

21. The household product of claim 19 wherein said solid particle is held between a plurality of said layers.

22. The household product of claim 19 wherein said one or more layers of material are selected from the group consisting of nonwoven materials, woven materials and hydroentangled materials.

23. A method of soil removal with a controlled delivery system which is a solid particle, said solid particle comprising an active agent and a cationic charge booster, said solid particle being formed of a hydrophobic polymer, hydrophobic copolymer, or a mixture thereof.

24. A method of deodorizing with a controlled delivery composition system which is a solid particle an active agent and a cationic charge booster, said solid particle being formed of a hydrophobic polymer, hydrophobic copolymer, or a mixture thereof.
